(19) United States
(12) Patent Application Publication
(10) Pub. No.: US 2011/0066641 A1
(43) Pub. Date: Mar. 17, 2011

(54) HANDLING ENUM QUERIES IN A COMMUNICATION NETWORK

(76) Inventors: Jipan Yang, Qingdao (CN); Xiaohua Hua, Shanghai (CN); Ping Chen, Jiangxi Province (CN)

(21) Appl. No.: 12/993,497

(22) PCT Filed: May 19, 2008
(86) PCT No.: PCT/CN2008/000961

§ 371 Date: Nov. 19, 2010

(51) Int. Cl. G06F 17/30

(52) U.S. Cl. 707/769; 707/E17.108

(57) ABSTRACT

A method and apparatus for handling an Enum query in a communication network. An Enum server receives an Enum query sent from an Enum client. The Enum server determines that the query requires the Enum server to contact a remote node, such as a Number Portability database, in order to respond to the query. In addition to sending a remote node query to the remote node, the Enum server estimates a response time for replying to the Enum client. The estimated response time is estimated based on latency statistics relating to the remote node and stored at the Enum server. The Enum server sends a message containing the estimated response time to the Enum client. By sending an estimated response time to the Enum client, it allows the Enum client to delay retransmitting the Enum query to the Enum server in the event that the Enum client has not received a response before the Enum query retransmission timer times out.

### TECHNICAL FIELD

The invention relates to the field of handling Enum queries in a communication network.

### BACKGROUND

The IP Multimedia Subsystem (IMS) is the technology defined by the Third Generation Partnership Project (3GPP) to provide IP Multimedia services over both mobile and fixed communication networks. IP Multimedia services provide a dynamic combination of voice, video, messaging, data, etc. within the same session.

The IMS makes use of the Session Initiation Protocol (SIP) to set up and control calls or sessions between user terminals. The Session Description Protocol (SDP), carried by SIP signals, is used to describe and negotiate the media components of the session. Whilst SIP was created as a user-to-user protocol, the IMS allows operators and service providers to control user access to services and to charge users accordingly.

FIG. 1 illustrates schematically how the IMS fits into the mobile network architecture in the case of a General Packet Radio Service (GPRS) access network. As shown in FIG. 1 control of communications occurs at three layers (or planes). The lowest layer is the Connectivity Layer 1, also referred to as the bearer plane and through which signals are directed to/from user equipment, UE, accessing the network. The entities within the connectivity layer 1 that connect an IMS subscriber to IMS services form a network that is referred to as the IP-Connectivity Access Network, IP-CAN. The GPRS network includes various GPRS Support Nodes (GSNs). A gateway GPRS support node (GGSN) 2 acts as an interface between the GPRS backbone network and other networks (radio network and the IMS network). The middle layer is the Control Layer 4, and at the top is the Application Layer 6.

The IMS 3 includes a core network 3a, which operates over the middle, Control Layer 4 and the Connectivity Layer 1, and a Service Network 3b. The IMS core network 3a includes nodes that send/receive signals to/from the GPRS network via the GGSN 2a at the Connectivity Layer 1 and network nodes that include Call/Session Control Functions (CSCFs) 5, which operate as SIP proxies within the IMS in the middle, Control Layer 4. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF. The top, Application Layer 6 includes the IMS service network 3b. Application Servers (ASs) 7 are provided for implementing IMS service functionality

Number Portability (NP) allows the transfer of an existing fixed line or mobile telephone number assigned by one network operator to another network operator. This allows a user to change the network operator that provides them with a telephony service to another network operator, whilst retaining their number. There may be restrictions on transferability of a number from one network operator to another, depending on location and access technology. IMS networks are also required to allow for NP between different network operators, as described in RFC 3482.

In one solution to provide for NP, NP information can be retrieved from an external NP database via an Enum Server, as illustrated in FIG. 2. A CSCF 8 queries an Enum server 9 using an Enum Query/Response mechanism (which uses the Domain Name Server, DNS, protocol). The Enum Server 9 then queries at least one of a number of NP databases 10-15. The interface between the Enum Server 9 and the NP databases may include an SS7 protocol such as Telcordia Advanced Intelligent Network (AIN), Intelligent Network Application Protocol (INAP), Mobile Application Part (MAP), Lightweight Directory Access Protocol (LDAP), XML, or even DNS protocol. Note that whilst FIG. 2 illustrates the case where the CSCF 8 relies on the Enum Server 9 to obtain NP information, the CSCF 8 also relies on the Enum Server 9 for a straightforward Enum query where NP information is not required.

Statistics from 2006 indicate that GSM Mobile Switching Centres (MSCs) use around 40-45% of their total call processing on NP related signalling (as opposed to regular Enum query signalling). It can be assumed that these numbers would be significantly higher in an IMS network.

For ordinary Enum queries between the CSCF 8 and the Enum Server 9 that do not require NP support, the usual response latency is typically less than 5 ms. For a Transaction Capabilities Application Part (TCAP) query, the latency has a mean value of 0.25 to 0.5 s. For a query using LDAP, SQL, XML protocols to proprietary NP databases, the latency can range from 10 ms to several seconds.

The CSCF 8 (in its capacity as the Enum client) makes use of a fixed timer to deal with retransmission in all the situations. If a response to a query is not received within a predetermined period of time, then the query is retransmitted. The DNS_Retransmission_Timer default value for the CSCF 8 as an Enum client is 10 ms, but in practice this retransmission timer for an ENUM query is usually set to 100 ms.

Ordinary Enum Query Latency, where NP support is not required, is defined as latency caused between the Enum client 8 and the Enum server 9 (which is usually around 5 ms, as described above). NP related Enum Query Latency is defined as the sum of latency caused between the Enum client 8 and the Enum server 9 and latency caused between the Enum server 9 and an NP database 10 (which could range from 250 ms to several seconds). NP related Enum Query Latency can fluctuate greatly.

However, for the CSCF as an Enum client, the processing latency of an INVITE request is typically less than 140 ms for 95% of all non NP related requests. This latency includes the time for an authentication query to a Home Subscriber Server (HSS), and for querying the external Enum server 9.

In the CSCF 8, the DNS Retransmission Timer default value is usually set to 10 ms, which corresponds to the 5 ms ordinary Enum query taking account of Enum query UDP packet loss. However, even though in a real IMS network the retransmission timer for the ENUM query is set to 100 ms, there may be a problem caused by extra ENUM query latency between the Enum Server 9 and the NP database 10 where NP support is required. The extra NP query latency is typically 250˜350 ms if the interface to external NP database is SS7 related protocol. However, if the external database 10 is outside of the realm of IMS network, then the IMS network has no control over the latency introduced by the NP query, and the latency could fluctuate from several hundreds ms to several seconds based on external network conditions and which protocol is used between the Enum server 9 and the external NP database 10.

It is not practical to maintain the 100 ms retransmission timer for all NP related Enum Queries, as this might result in several consecutive failure for SS7 related NP query in a good SS7 network. This would waste a large amount of bandwidth resources and processing power in handling the Enum queries in the IMS network, considering that over 40% of queries are expected to require NP support.

A possible solution to this problem is to set the CSCF 8 Enum query retransmission timer value to 400 ms or larger for SS7 related NP queries. If the link between the CSCF 8 and the Enum server 9, and the SS7 link between the Enum Server 9 and the external NP database 10 are in perfect condition, the 400 ms Enum query retransmission timer is a good solution, as retransmission is not necessary. However, this solution fails where some packet loss occurs between the CSCF 8 and Enum Server 9. In this case, for an ordinary Enum Query, the CSCF 8 has to wait 400 ms to retransmit the query, and so the total query time cost will increase from around 105 ms (100 ms+Ordinary Enum Query Latency) to around 405 ms (400 ms+Ordinary Enum Query Latency) comparing with the timer being set to 100 ms. This is a drawback for CSCF call processing. For an Enum Query requiring NP support, the latency would be 400 ms+NP related Enum Query Latency (here we assume NP related Enum Query Latency is less than 400 ms).

As stated above, the IMS network has no control over the external network where the external NP database 10 resides. If the SS7 NP dip latency becomes larger than 400 ms, then all NP dip related Enum queries from the CSCF 8 will fail at least once, and the total Enum query latency will be more than 800 ms (2*NP related Enum Query Latency). This will have a significant impact on the performance of the IMS network and the user's experience.

If the retransmission timer is set to a much larger value, for example, 3 seconds, to completely to remove the possibility of unnecessary Enum query retransmission to cope with the worst SS7 network situation, then when packet loss occurs between the CSCF 8 and the Enum Server 9, the ordinary Enum queries have to wait 3 seconds as well instead of the usual 100 ms if the timer value is 100 ms. Requiring the call signalling flow to wait for 3 seconds at the CSCF 8 is not acceptable in an IMS network.

### SUMMARY

The inventors have realised the problems associated with the latency incurred when an Enum server needs to make an external query before responding to an Enum Query, and has devised a method and apparatus for mitigating these problems.

According to a first aspect of the invention, there is provided a method of handling an Enum query in a communication network. An Enum server receives an Enum query sent from an Enum client. The Enum server determines that the query requires the Enum server to contact a remote node in order to respond to the query. In addition to sending a remote node query to the remote node, the Enum server estimates a response time for replying to the Enum client. The estimated response time is estimated based on latency statistics relating to the remote node and stored at the Enum server. The Enum server sends a message containing the estimated response time to the Enum client. When the Enum server receives a response from the remote node, it sends an Enum response to the Enum client, the response having been generated using information obtained from the remote node. By sending an estimated response time to the Enum client, it allows the Enum client to delay retransmitting the Enum query to the Enum server in the event that the Enum client has not received a response before the Enum query retransmission timer times out.

In an optional embodiment of the invention, the remote node is a Number Portability database node. This is a common circumstance where the Enum server is required to contact a remote node.

Optionally, the Enum client is a Call Session Control Function node located in an IP Multimedia Subsystem network.

In order to improve the accuracy of estimating the response time during changing network condition, the response time is optionally estimated by giving a greater weighting to more recent latency statistics.

The response time estimate optionally includes a margin of error. This effectively increases the estimated response time in order to prevent unnecessary retransmission of the Enum query from the Enum client where the Enum response is sent soon after the Enum client's query retransmission timer times out.

As an option, the method comprises updating the latency statistics stored at the Enum server with latency information obtained from the response received from the remote node. This ensures that the latency statistics stored at the Enum server are up to date. Updating may be done for every response received from the remote node, or for only some responses received from the remote node.

According to a second aspect of the invention, there is provided an Enum server comprising a memory for storing latency statistics relating to a remote node, a first receiver for receiving from an Enum client an Enum query, and a first processor for determining that the query requires the Enum server to contact the remote node in order to respond to the query. The first processor is also arranged to estimate a response time based on the latency statistics. A first transmitter is provided for sending a message to the Enum client, the message including the estimated response time. This allows the Enum client to delay retransmission of the Enum query in the event that it has not received an Enum response before the Enum client's Enum query retransmission query timer times out. The Enum server is also provide with a second transmitter for sending to the remote node a remote node query, and a second receiver for receiving from the remote node a response. A further transmitter is used for sending an Enum Response generated using information obtained from the remote node to the Enum client.

As an option, the remote node is a Number Portability database node. The Enum client is optionally located in an IP Multimedia Subsystem network.

Optionally, a second processor is provided for updating the latency statistics stored in the memory with latency information obtained from the response. This ensures that the latency statistics stored at the Enum server are up to date. Updating may be done for every response received from the remote node, or for only some responses received from the remote node.

According to a third aspect of the invention, there is provided an Enum client node that is provided with a transmitter for transmitting an Enum query to an Enum server. The Enum client node is also provide with a receiver for receiving from the Enum server a message, the message including an estimated response time for responding to the Enum query. A processor is provided for determining that a response to the Enum query has not been received after the expiry of the later of the estimated response time and the predetermined retransmission time, and in that event, instructing the transmitter to retransmit the Enum query. This reduces unnecessary retransmissions of the Enum query in the event that a response to the query has not been received by the expiry of the retransmitted time owing to the fact that the Enum server is experiencing delays in contacting any remote nodes necessary for responding to the Enum query.

As an option, the Enum client node is a Call Session Control Function in an IP Multimedia Subsystem network.

### BRIEF DESCRIPTION OF THE DRAWINGS

FIG. 1 illustrates schematically in a block diagram an IMS network in association with a mobile network architecture of a General Packet Radio Service (GPRS) access network;

FIG. 2 illustrates schematically in a block diagram a network architecture for providing for number portability in an IMS network;

FIG. 3 is a signalling diagram illustrating signalling between an Enum client, an Enum Server and an NP database according to an embodiment of the invention;

FIG. 4 is a flow diagram showing steps according to an embodiment of the invention;

FIG. 5 illustrates schematically in a block diagram an Enum server node according to an embodiment of the invention; and

FIG. 6 illustrates schematically in a block diagram an Enum client node according to an embodiment of the invention.

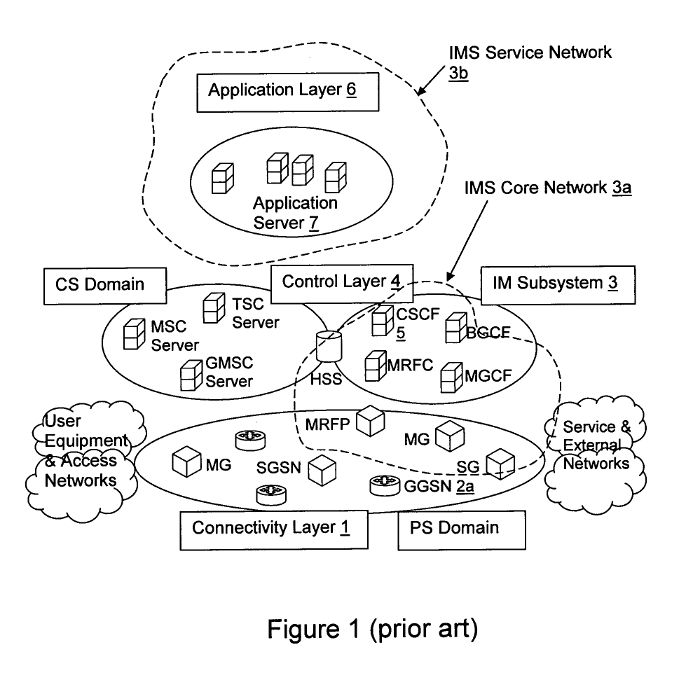

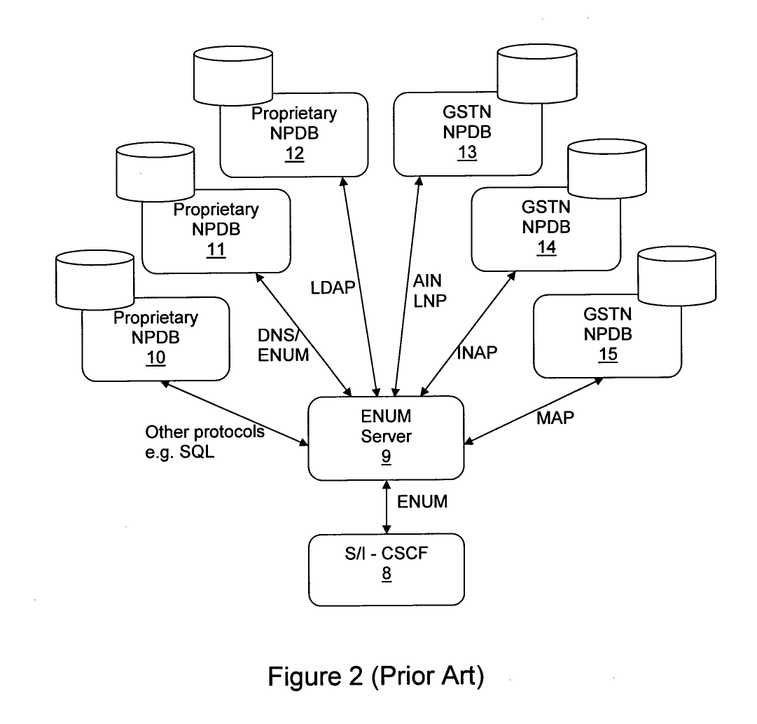

### DETAILED DESCRIPTION

An Enum client (for example a CSCF in an IMS network) 8 has a 10 ms or 100 ms retransmission timer value for all Enum queries that it makes. If a response is not returned to an Enum query in that time, then the query will be re-submitted. An Enum server 9 records latency statistics for all Number Portability (NP) queries that the Enum server 9 makes to a remote NP database 10. When the Enum server 9 receives an incoming Enum query from an Enum client 8 that requires a NP query, the Enum server 9 responds the Enum client 8 with a message that provides the estimated latency. The estimated latency is calculated based on the recorded latency statistics. The Enum client 8 delays retransmission of the Enum query until the estimated latency time is over.

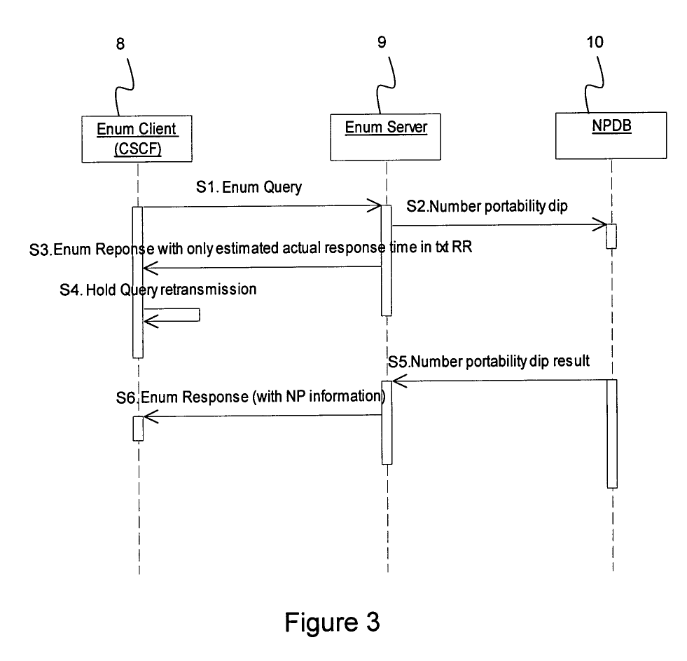

Referring to FIG. 3, a signalling diagram illustrating signalling between an Enum client 8, an Enum Server 9 and a NP database 10 is shown. The following numbering corresponds to the numbered signals of FIG. 3.

S1. An Enum client 8 sends an Enum NP request to the Enum Server 9 on port 53.
S2. The Enum Server 9 processes the request and checks whether the request requires a NP Query. If the request does require a NP Query, it is forwarded to a NPDB 10.
S3. The Enum Server 9 generates a reply containing a DNS TXT Record, which includes an estimated response time to the Enum client 8. The estimated response time is calculated on the basis of latency records stored at the Enum server 9.
S4. On receipt of the reply, the Enum client 8 holds the query retransmission until either the Enum NP Response or estimated latency times out.
S5. The NPDB 10 sends a response to the NP Query to the Enum server 9. The Enum server 9 also updates the stored statistics with latency information from the NPDB 10.
S6. The Enum server 9 sends an Enum response to the Enum client 8.

The above sequence provides one example of how the Enum client 8 uses the latency information provided by the Enum server 9 in step S3. However, the Enum client 8 can make uses of the estimated response time supplied by the Enum server 9 in different ways. For example, the Enum client 8 in one embodiment may find that the estimated response time is larger than the Enum client's existing retransmission timer. In this case, the Enum client 8 can either use the estimated response time as a temporary timer before retransmitting the query. This avoids unnecessary retransmission of the query, or the Enum client 8 unnecessarily dropping the query. If, however, the Enum client 8 receives the estimated response time and determines that this is lower than the existing retransmission time and finds it is smaller than its retransmission timer. In this the Enum client 8 uses the retransmission timer value to determine when a retransmission of the query is required, and need do nothing further

The estimated response time is calculated based on the latency statistics stored at the Enum server 9 of the most recent n (number of queries) NP queries that used the same external querying protocol (as the Enum server may be capable of querying a number of external databases that use different querying protocols and have different latencies). In an embodiment of the invention, the more recent the latency sample is, the heavier weight it has in the calculation. A small delta value is added to the estimated response time to provide a margin of error and assist the Enum client 8 in adjusting its retransmission behaviour. The delta value allows the operator to build a margin of error in the estimated response time to avoid unnecessary retransmissions.

Assume that the latest n+1 samples are available, with values L₀˜Lₙ with corresponding sampling time T₀˜Tₙ, where T₀ is the oldest time among the n+1 samples and Tₙ is the most recent time. In an embodiment of the invention, the following formula is used to estimate the next latency value:

$$L = ( {\sum }_{i = 1}^{i = n} \frac{( {T}_{i} - {T}_{0} ) {L}_{i}}{{T}_{1} + {T}_{2} + … + {T}_{n} - {nT}_{0}} ) ( 1 + Δ )$$

(n>=2, and is configurable with a default value of 50)
Tᵢ is the sampling time
Lᵢ is the sample latency value (ms)
Δ is adjustable; and
L is the estimated latency for this NP query.

In the above formula, it can be seen that each sample of latency data has a weight and the more recent the latency sample is, the heavier the weight is.

Lᵢ has the corresponding weight

$$\frac{{T}_{i} - {T}_{0}}{{T}_{1} - {T}_{0} + {T}_{2} - {T}_{0} + … + {T}_{n} - {T}_{0}} = \frac{{T}_{i} - {T}_{0}}{{T}_{1} + {T}_{2} + … + {T}_{n} - {nT}_{0}}$$

Rather than sampling every query, the sample may be taken from every m^{th} query, where m is configurable from 1˜10000, and has a default value 50.

Δ is used to give some margin to the estimated response time, so that it could be a little larger than the real response time to avoid retransmission. In an embodiment of the invention, it is configurable with a default value 0.05, and a range from 0˜0.2

Note that the formula given above is provided by way of example only to illustrate the basic principle of estimating the next query response time based on history latency statistics.

As described above, the Enum response in step S3 contains a DNS TXT record. In an embodiment of the invention, the information in the DNS TXT Record is formatted as a series of Name/Value pairs as shown in Table 1:

TABLE 1
DNS TXT Record format

| Name | Values | Comments |
|---|---|---|
| ET | Integer value n (1-99) | ENUM Query Type. |
| | | 1: Ordinary Enum Query |
| | | 2: AIN |
| | | 3: MAP |
| | | 4: INAP |
| | | 5: LDAP |
| | | 6~99: reserved for future usage |
| EL | Integer value n (10-3000 ms) | Estimated Latency of NP Queries, |
| | | for use by Enum Client. |

As an example:
1.2.3.4.5.e164.abc.com. 0 IN TXT “ET=2\nEL=300\n”

The name and value are separated by an equals sign (=), and the delimiter for Name/Value pairs is a LF character (\n).

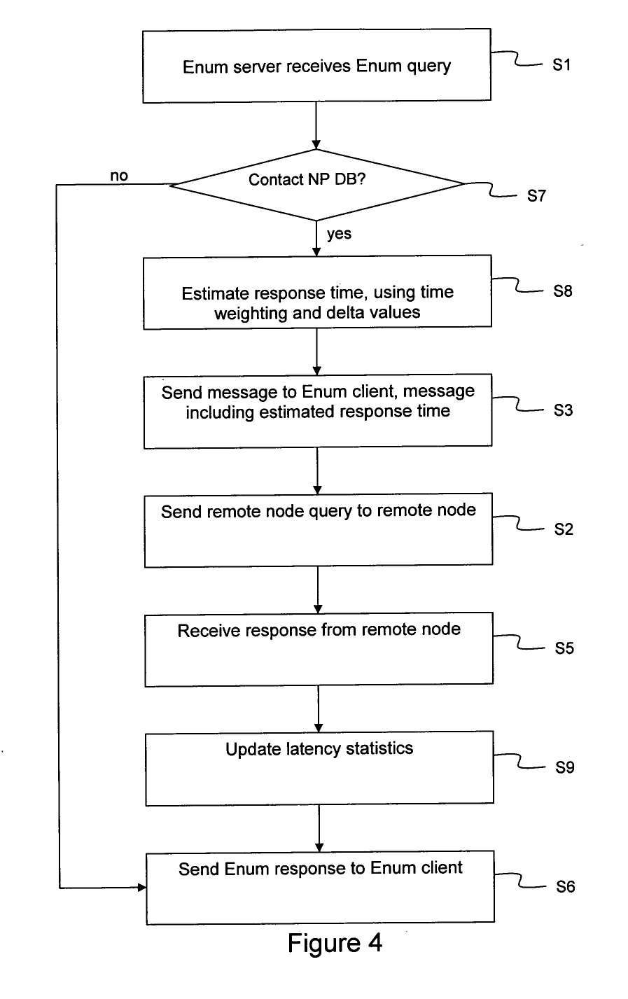

Referring now to FIG. 4, there is shown a flow diagram illustrating in more detail the steps taken at the Enum server 9. The following numbering corresponds to the numbering in FIG. 4:

S1. The Enum server 9 receives an Enum query from the Enum client 8.
S7. The Enum server 9 determines from the Enum query if it needs to contact the NPDB 10. If not, then move to step S6, if so then move to step S8.
S8. The Enum server 9 estimates the response time based on stored latency statistics, and may use weighting and delta values as described above.
S3. The Enum server 9 sends a message to the Enum client 8 informing it of the estimated response time. The Enum client can adjust its retransmission behaviour according to the estimated response time.
S2. The Enum server 9 also sends a NP query to the NPDB 10.
S5. The Enum server 9 receives a NP response from the NPDB 10.
S9. The Enum server 9 updates its latency statistics with latency information obtained in step S5.
S6. The Enum server 9 sends an Enum response message (which contains NP information if required) to the Enum client 8.

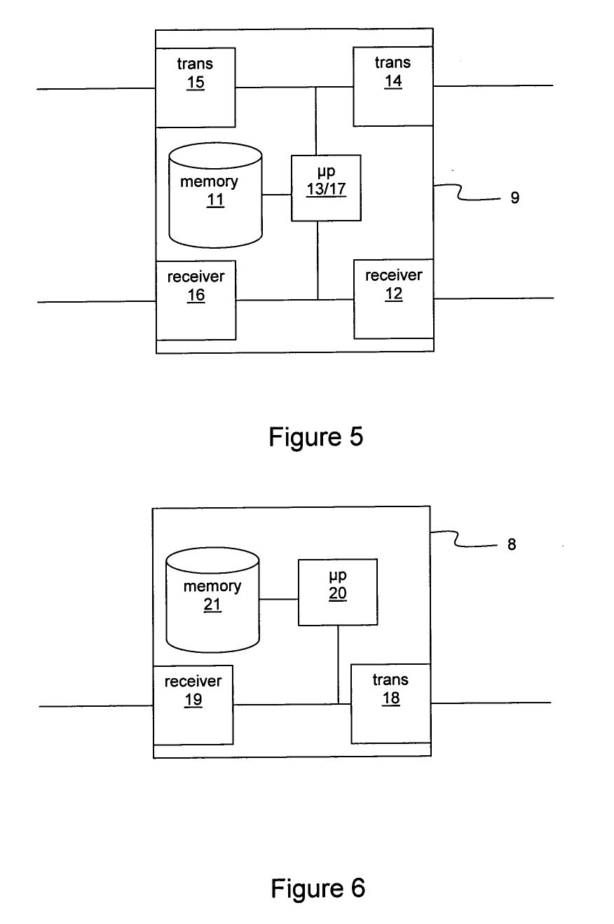

Turning now to FIG. 5, there is illustrated an Enum Server 9. The Enum server comprises a memory 11 for storing latency statistics relating to a remote NPDB 10. A first receiver 12 is provided for receiving Enum queries from one or more Enum clients. A first processor 13 is arranged to determine whether the query requires the Enum server 9 to contact the NPDB 10 in order to respond to the query, and to estimate a response time based on the stored latency statistics. A first transmitter 14 is provided for sending a message to the Enum client 8, the message including the estimated response time. A second transmitter 15 is provided for sending a NP query to the NPDB 10, and a second receiver 16 (which may be embodied in the first receiver) is arranged to receive a response from the NPDB containing NP information. A second processor 17 (which may be embodied in the first processor) is provided for updating the latency statistics stored in the memory 11 with latency information obtained from the response. The first transmitter 14 is also arranged to send an Enum Response to the Enum client 8, the Enum response having been generated using information obtained from the NPDB 10.

Referring to FIG. 6 herein, there is illustrated an Enum client node 8, such as a CSCF, according to an embodiment of the invention. The client node 8 comprises a transmitter 18 for sending an Enum query to an Enum server 9. A receiver 19 is also provided. The receiver 19 is arranged to receive a message from the Enum server 9 that includes an estimated response time by which the Enum client node 9 can expect a response from the Enum server 9. A processor 20 is provided for determining whether a response to the Enum query has been received after the expiry of the later of the estimated response time and the predetermined retransmission time. In the event that a response has not been received, the processor 20 is arranged to instruct the transmitter 18 to retransmit the Enum query. The predetermined transmission time, and the received estimated response time may be stored in a memory 21.

The invention reduces the Enum query time in scenarios of poor network conditions where packet loss occurs and Enum queries need to be retransmitted. The Enum client is provided with an estimated response time, which allows it to optimize the NP related signal processing. The invention also allows the Enum client to flexibly deal with changing network conditions by adjusting the fixed timer.

It will be appreciated by the person of skill in the art that various modifications may be made to the above-described embodiments without departing from the scope of the present invention. For example, the invention has been described with reference to an IMS network and a CSCF being the Enum client, but the invention would similarly work in any type of communication network that uses an Enum client to query an Enum server. Furthermore, the invention has been described in the context of latency introduced in the system by the Enum server having to make a NP query. However, it will be appreciated that the invention could equally be used where latency is introduced by the Enum server having to send a different type of query to a remote node.

The following abbreviations have been used in the description:

### CSCF Call Session Control Function

### DNS Domain Name System

### ENUM E.164 Number Mapping

### IMS Internet Protocol Multimedia Subsystem

### NP Number Portability

NPDB Number Portability Database

1. A method of handling an Enum query in a communication network, the method comprising:
at an Enum server, receiving an Enum query sent from an Enum client;
determining that the query requires the Enum server to contact a remote node in order to respond to the query;
estimating a response time based on latency statistics relating to the remote node and stored at the Enum server
sending a remote node query to the remote node;
sending a message to the Enum client, the message including the estimated response time;
receiving from the remote node a response;
sending to the Enum client an Enum Response generated using information obtained from the remote node.

2. The method according to claim 1, wherein the remote node is a Number Portability database node.

3. The method according to claim 1, wherein the Enum client is a Call Session Control Function node located in an IP Multimedia Subsystem network.

4. The method according to claim 1, wherein the response time is estimated by giving a greater weighting to more recent latency statistics.

5. The method according to claim 1, wherein the response time estimate includes a margin of error.

6. The method according to claim 1, further comprising updating the latency statistics stored at the Enum server with latency information obtained from the response received from the remote node.

7. An Enum server comprising:
a memory for storing latency statistics relating to a remote node;
a first receiver for receiving from an Enum client an Enum query;
a first processor for determining that the query requires the Enum server to contact the remote node in order to respond to the query, and for estimating a response time based on the latency statistics
a first transmitter for sending a message to the Enum client, the message including the estimated response time;
a second transmitter for sending to the remote node a remote node query;
a second receiver for receiving from the remote node a response; and
a further transmitter for sending to the Enum client an Enum Response generated using information obtained from the remote node.

8. The Enum server according to claim 7, wherein the remote node is a Number Portability database node.

9. The Enum server according to claim 7, wherein the Enum client is located in an IP Multimedia Subsystem network.

10. The Enum server according to claim 7, further comprising a second processor for updating the latency statistics stored in the memory with latency information obtained from the response.

11. An Enum client node comprising:
a transmitter for transmitting to an Enum server an Enum query;
a receiver for receiving from the Enum server a message, the message including an estimated response time for responding to the Enum query;
a processor for determining that a response to the Enum query has not received after the expiry of the later of the estimated response time and the predetermined retransmission time, and in that event, instructing the transmitter to retransmit the Enum query.

12. The Enum client node according to claim 11, wherein the Enum client node comprises a Call Session Control Function in an IP Multimedia Subsystem network.
